(19) United States
(12) Patent Application Publication
(10) Pub. No.: US 2014/0181359 A1
(43) Pub. Date: Jun. 26, 2014

(54) INFORMATION PROCESSING APPARATUS AND METHOD OF COLLECTING MEMORY DUMP

(71) Applicant: FUJITSU LIMITED, Kawasaki-shi (JP)

(72) Inventors: Xiaoyang ZHANG, Kawasaki (JP); Fumiaki YAMANA, Sunnyvale, CA (US); Kenji GOTSUBO, Yokohama (JP); Hiroyuki IZUI, Kawasaki (JP)

(73) Assignee: FUJITSU LIMITED, Kawasaki-shi (JP)

(21) Appl. No.: 14/190,669

(22) Filed: Feb. 26, 2014

Related U.S. Application Data
(63) Continuation of application No. PCT/JP2011/069500, filed on Aug. 29, 2011.

(51) Int. Cl. G06F 12/08; G06F 9/455

(52) U.S. Cl. CPC G06F 12/08; G06F 9/455
USPC 711/6

(57) ABSTRACT

An information processing apparatus running multiple virtual machines includes a correspondence information storage section configured to store correspondence information between a virtual address and a physical address, the correspondence information being used by a second virtual machine when executing a procedure relevant to a first virtual machine; a correspondence information processing section configured to invalidate the correspondence information in response to an occurrence of a panic in the first virtual machine; and a preservation section configured to preserve content of a memory area allocated to the second virtual machine into a storage device.

### CROSS-REFERENCE TO RELATED APPLICATIONS

This application is a continuation application of International Application PCT/JP2011/069500 filed on Aug. 29, 2011 and designated the U.S., the entire contents of which are incorporated herein by reference.

### FIELD

The disclosures herein generally relate to an information processing apparatus and a method of collecting a memory dump.

### BACKGROUND

An operating system (OS) executes a panic handling procedure for an emergency stop if detecting a fatal error. In this case, the operating system preserves content of a memory in use in a hard disk as a memory dump, then restarts the system. The memory dump is used for investigation of a cause of the fatal error.

If a physical machine (computer) and an OS have one to one correspondence, a domain of the OS has higher independence from other domains. Therefore, if a panic occurs in a domain, it may have little influence on the other domains.

On the other hand, in recent years, computer virtualization technologies for computers have been spread. Using such virtualization technologies, multiple virtual machines (domains) can run on a single physical machine. Each of the domains can run an individual operating system. Namely, multiple operating systems can operate on a single physical machine.

In a virtualized environment, a domain may have a special role. For example, a “service domain” provides a service of virtualized devices to the other domains, and a “guest domain” uses the service provided by the service domain. If a panic occurs in a certain guest domain in such a virtualized environment, there is a likelihood that a problem on a service domain is a cause of the panic.

FIG. 1 is a schematic view of an example in which a fault on a service domain causes a panic in a guest domain. In FIG. 1, a hypervisor runs three domains (virtual machines), which are a service domain, a guest domain A, and a guest domain B. Here, a hypervisor is software for virtualizing a computer that makes it possible to run multiple OSes in parallel. A hypervisor activates a virtual computer (virtual machine) implemented in software to run an OS on the virtual machine.

For example, suppose that a fault (S1) occurs in the service domain while the service domain is offering a service to the guest domain B. If a panic (S2) occurs in the guest domain B due to an influence of the fault, content of a memory used by the guest domain B is stored as a memory dump (S3).

However, in the case in FIG. 1, a memory dump of the service domain also needs to be collected, otherwise, it is difficult to identify a true cause of the panic in the guest domain B. Even if the memory dump of the guest domain B is analyzed, the occurrence of the fault in the service domain may not be identified. Also, even if the occurrence of the fault is identified, it is difficult to identify a cause of the fault.

Thereupon, a memory dump is conventionally collected on such a service domain by a method illustrated in FIG. 2.

FIG. 2 is a schematic view illustrating a method of collecting a memory dump on a service domain. In FIG. 2, Steps S1-S3 are the same as in FIG. 1.

In FIG. 2, in response to an occurrence of a panic on a guest domain B, a user manually generates a panic on a service domain (S4). Consequently, content of a memory used by the service domain is preserved as a memory dump (S5).

However, there is a problem with the method in FIG. 2 in that if the service domain provides a service to guest domains other than the guest domain B (a guest domain A in FIG. 2), the service being offered to the guest domain A also comes to a stop.

Thereupon, a technology called live dump is used for collecting a memory dump while an operating system of the service domain is running.

### RELATED-ART DOCUMENTS

### Patent Documents

[Patent Document 1] Japanese Laid-open Patent Publication No. 2005-122334
[Patent Document 2] Japanese Laid-open Patent Publication No. 2001-229053

However, if using the live dump technology for correcting a memory dump, there is a likelihood that content of a memory to be collected may be updated by a running domain (service domain) while collecting the memory dump. Namely, the content of the memory dump collected using the live dump technology may become different from content of the memory of the service domain just when the fault occurs in the service domain. Therefore, the collected memory dump may lose consistency of data, hence it is in a state that cannot be analyzed, or in a state where important information for identifying a cause is lost, which may not be useful as material for investigating a cause of the panic.

### SUMMARY

According to an embodiment of the present invention, an information processing apparatus running multiple virtual machines includes a correspondence information storage section configured to store correspondence information between a virtual address and a physical address, the correspondence information being used by a second virtual machine when executing a procedure relevant to a first virtual machine; a correspondence information processing section configured to invalidate the correspondence information in response to an occurrence of a panic in the first virtual machine; and a preservation section configured to preserve content of a memory area allocated to the second virtual machine into a storage device.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view of an example in which a fault on a service domain causes a panic in a guest domain;

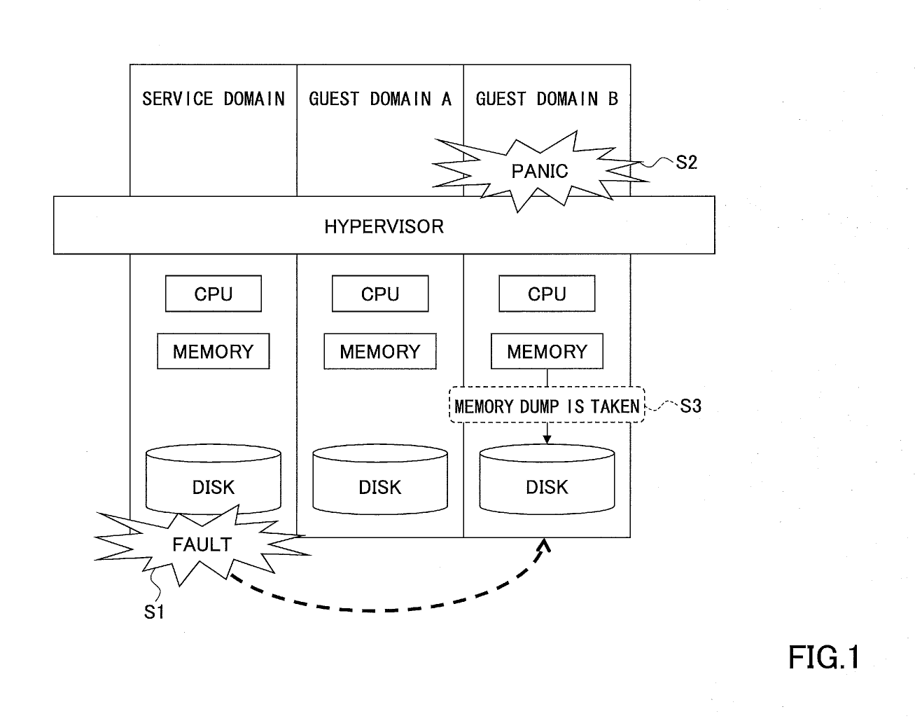

FIG. 2 is a schematic view illustrating a method of collecting a memory dump on a service domain;

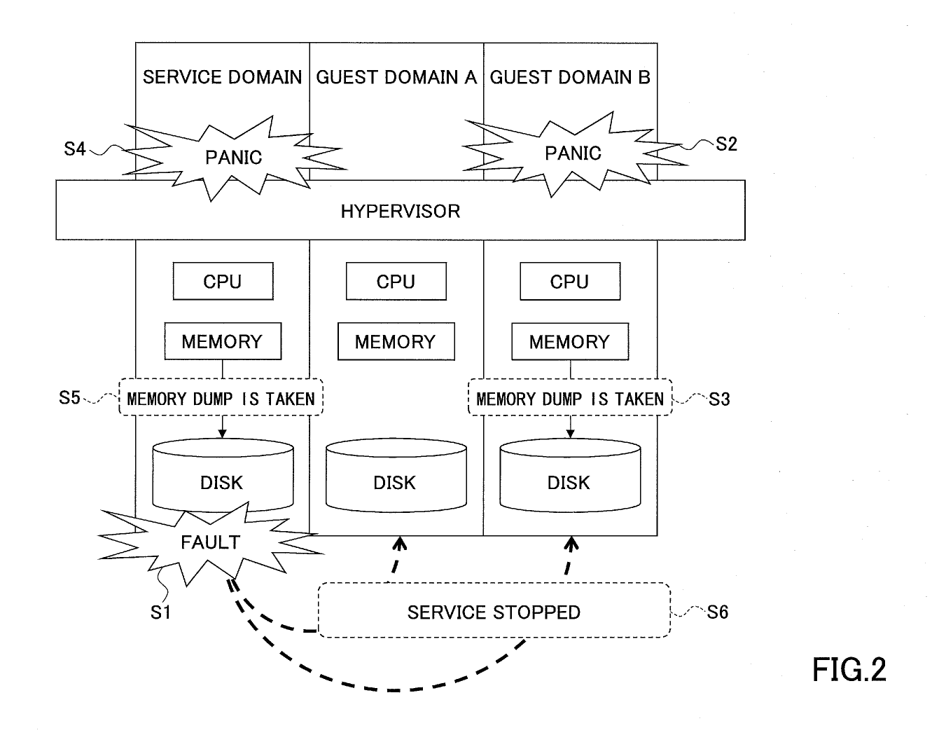

FIG. 3 is a schematic view illustrating an example of a hardware configuration of an information processing apparatus according to an embodiment of the present invention;

FIG. 4 is a schematic view illustrating an example of a software configuration of an information processing apparatus according to an embodiment of the present invention;

FIG. 5 is a sequence chart illustrating an example of a procedure executed when a panic occurs in a guest domain;

FIG. 6 is a schematic view illustrating an example of a procedure for collecting a memory dump of a domain where a panic occurs;

FIG. 7 is a schematic view illustrating an example of a configuration of a domain relation storage section;

FIG. 8 is a schematic view illustrating an example of a procedure for collecting a memory dump of a service domain;

FIG. 9 is a schematic view illustrating an example of a trap generated in response to invalidation of an address translation buffer;

FIG. 10 is a schematic view illustrating an example of a procedure for resetting an address translation buffer;

FIG. 11 is a flowchart illustrating an example of a procedure executed by a hypervisor in response to a detection of a trap;

FIG. 12 is a schematic view illustrating a first example of a configuration of an address translation buffer;

FIG. 13 is a schematic view illustrating an example of a procedure for address translation using a TLB and an RR;

FIG. 14 is a schematic view illustrating a second example of a configuration of an address translation buffer; and

FIG. 15 is a schematic view illustrating an example of a procedure for address translation using a TLB.

### DESCRIPTION OF EMBODIMENTS

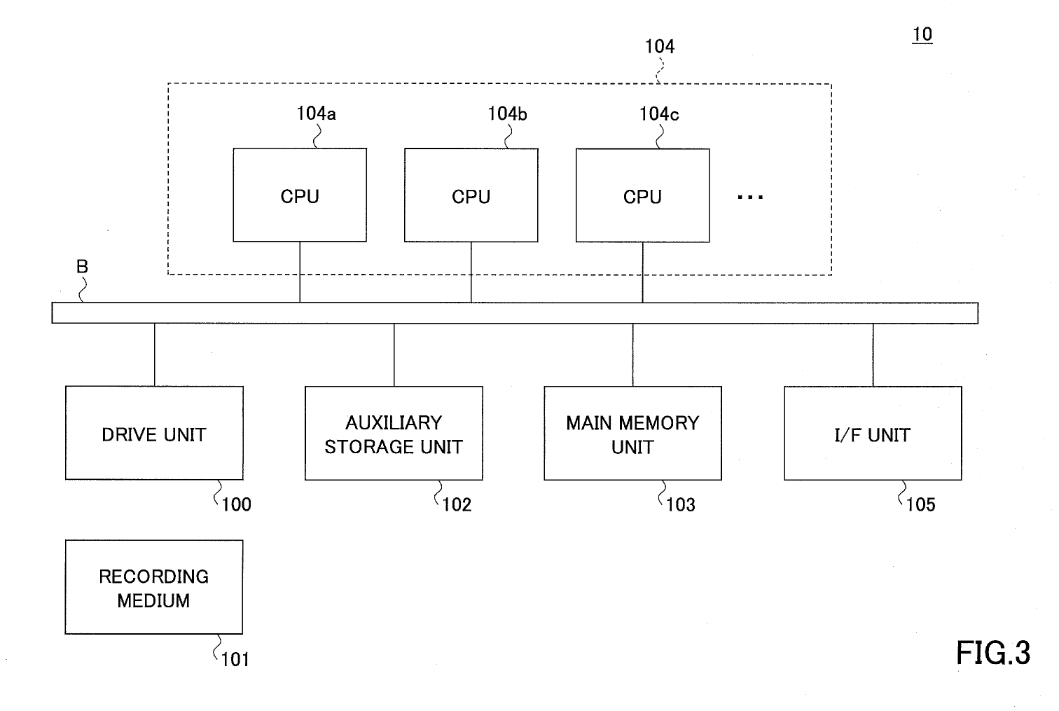

In the following, embodiments of the present invention will be described with reference to the drawings. FIG. 3 is a schematic view illustrating an example of a hardware configuration of an information processing apparatus 10 according to an embodiment of the present invention. In FIG. 3, the information processing apparatus 10 includes multiple CPUs 104 such as CPUs 104a, 104b, 104c, and the like. As will be described later, the CPUs 104 are allocated to virtual machines. Here, the information processing apparatus 10 may not necessarily be provided with the multiple CPUs 104. For example, a multi-core processor may replace the multiple CPUs 104. In this case, the processor cores may be allocated to the virtual machines.

The information processing apparatus 10 further includes an auxiliary storage unit 102, a main memory unit 103, an interface unit 105, and the like. The CPUs 104 and hardware elements are connected with each other by a bus B.

A program that performs processing on the information processing apparatus 10 is provided with a recording medium 101. When the recording medium 101 storing the program is set in the drive unit 100, the program is installed into the auxiliary storage unit 102 from the recording medium 101 via the drive unit 100. However, installation of the program is not necessarily executed from the recording medium 101, but may be downloaded from another computer via a network. The auxiliary storage unit 102 stores the installed program, and stores required files, data, and the like as well.

The main memory unit 103 reads the program from the auxiliary storage unit 102 to store the program into it when receiving a start command for the program. The CPU 104 implements functions relevant to the information processing apparatus 10 by executing the program stored in the main memory unit 103. The interface unit 105 is used as an interface for connecting with a network.

Here, an example of the recording medium 101 may be a CD-ROM, a DVD disk, or a portable recording medium such as a USB memory, etc. Also, an example of the auxiliary storage unit 102 may be an HDD (Hard Disk Drive), a flash memory, or the like. Both the recording medium 101 and the auxiliary storage unit 102 correspond to computer-readable recording media.

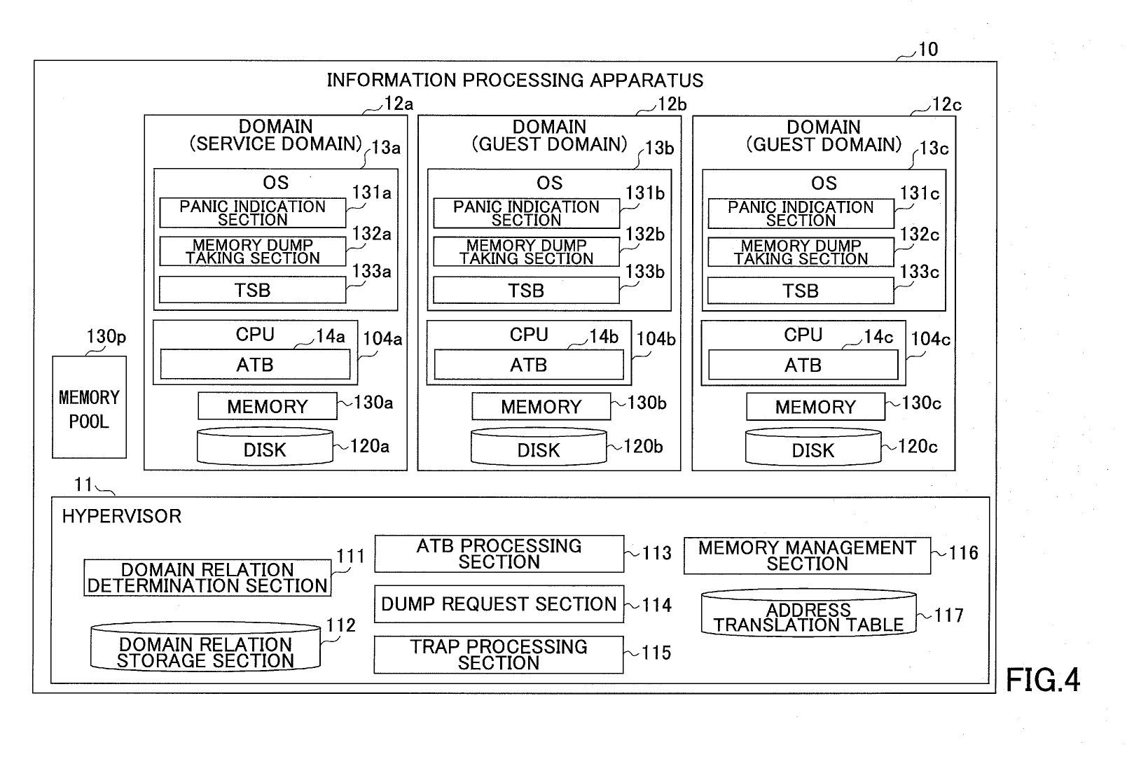

FIG. 4 is a schematic view illustrating an example of a software configuration of the information processing apparatus 10 according to the present embodiment of the present invention. In FIG. 4, the information processing apparatus 10 includes a hypervisor 11 and multiple domains 12 including a domain 12a to a domain 12c. The hypervisor 11 and the domains 12 are implemented by procedures that the program (virtualization program) installed on the information processing apparatus 10 has the CPUs 104 execute.

The hypervisor 11 virtualizes a computer to make it possible to run multiple OSes 13 in parallel. The hypervisor 11 creates a virtual computer (virtual machine) implemented in software to run an OS 13 on the virtual machine. Here, an execution unit of the virtual machine is called a “domain 12” according to the present embodiment. FIG. 4 illustrates a state where three execution units (domains 12), namely, the domain 12a, domain 12b, and domain 12c are executed on virtual machines, respectively.

In the present embodiment, the domain 12a, domain 12b, and domain 12c have respective roles different from each other. The domain 12a is one of the domains 12 that provides virtual environment services, such as virtual I/O or a virtual console, to the other domains 12. The domain 12b and the domain 12c are among the domains 12 that use the services provided by the domain 12a.

To grasp the difference of the roles of the domains 12 easier, the domain 12a is called the “service domain 12a” in the present embodiment. Also, the domain 12b and domain 12c are called the “guest domain 12b” and the “guest domain 12c”, respectively. It is simply called the “domain(s) 12” if no distinction is required.

Each of the domains 12 has hardware resources allocated by the hypervisor 11 that includes not only the CPU 104a, 104b, or 104c, but also memories 130a-130c and disks 120a-120c, and the like, respectively. The memories 130a-130c are partial storage areas in the main memory unit 103, respectively. Each of the domains 12 has the memory 130a, 130b, or 130c allocated that are not overlapped with each other in the main memory unit 103. The disks 120a-120c are partial storage areas in the auxiliary storage unit 102, respectively. Each of the domains 12 has the disk 120a, 120b, or 120c allocated that are not overlapped with each other in the auxiliary storage unit 102.

Each of the CPUs 104 includes an address translation buffer (ATB) 14. The address translation buffer 14 stores mapping information (correspondence information) to translate an address (a virtual address or an intermediate address), which is specified by the OS 13 when accessing the memory 130, into a physical address. A virtual address is an address in a virtual address space used by the OS 13, which will be denoted as a “virtual address VA” or simply a “VA”, hereafter. An intermediate address (also called a “real address”) is an address that corresponds to a physical address from the viewpoint of an operating system, which will be denoted as an “intermediate address RA” or simply a “RA”, hereafter. A physical address is a physically realized address in the main memory unit 103, which will be denoted as a “physical address PA” or simply a “PA”, hereafter.

The operating system (OS) 13 of each of the domains 12 includes a panic indication section 131, a memory dump taking section 132, a virtual-intermediate address translation buffer 133 (called a “TSB 133”, hereafter), and the like. The panic indication section 131 indicates a panic to the hypervisor 11 when executing a panic handling procedure in response to a fault having occurred on the domain 12. A fault is a state in which a fatal error is detected from which safe recovery cannot be made. With an execution of the panic handling procedure, the OS 13 executes an emergency stop.

The memory dump taking section 132 preserves (stores) content of the memory 130 (memory dump) of the domain 12 into the disk 120 of the domain 12 in response to an occurrence of a panic. However, as will be described later, there are cases in which the memory dump taking section 132 collects content of the memory 130 of one of the other domains 12 as a memory dump.

The TSB (Translation Storage Buffer) 133 holds mapping information between a virtual address VA and an intermediate address RA. The TSB 133 can be implemented using the memory 130 of the domain 12.

Here, in FIG. 4, alphabetical suffixes (a-c) are given to hardware resources and software resources of the domains 12 that are the same as the suffixes at the end of the numerical codes of the domains. If the hardware and/or software resources are referred to without making distinction among the domains 12, the alphabetical suffixes are omitted.

On the other hand, the hypervisor 11 includes a domain relation determination section 111, a domain relation storage section 112, an address translation buffer (ATB) processing section 113, a dump request section 114, a trap processing section 115, a memory management section 116, an address translation table 117, and the like.

The domain relation determination section 111 determines a service domain 12 of another domain 12. Namely, although the domain 12A is assumed to be a service domain in the present embodiment for convenience's sake, whether one of the domains 12 is a service domain or not is a relationship relative to the other domains 12. The domain relation storage section 112 stores information about the service domain 12 of each of the domains 12. The ATB processing section 113 clears (invalidates) or resets the mapping information stored in the address translation buffer 14. The dump request section 114 makes a request for collecting a memory dump on a domain 12 (for example, the service domain 12a) to another domain 12 (for example, the guest domain 12c). The trap processing section 115 executes a procedure for a trap indicated by the CPU 104 of a domain 12. A trap is an indication of an occurrence of an exception from the hardware to the software, or information itself indicated with the indication. The memory management section 116 executes a procedure relevant to the memory 130 of the domain 12.

The address translation table 117 stores mapping information between an intermediate address RA and a physical address PA. The information stored in the address translation table 117 is generated and managed by the hypervisor 11.

Here, a memory pool 130p in FIG. 4 is a storage area not allocated to any of the domains 12 in the main memory unit 103.

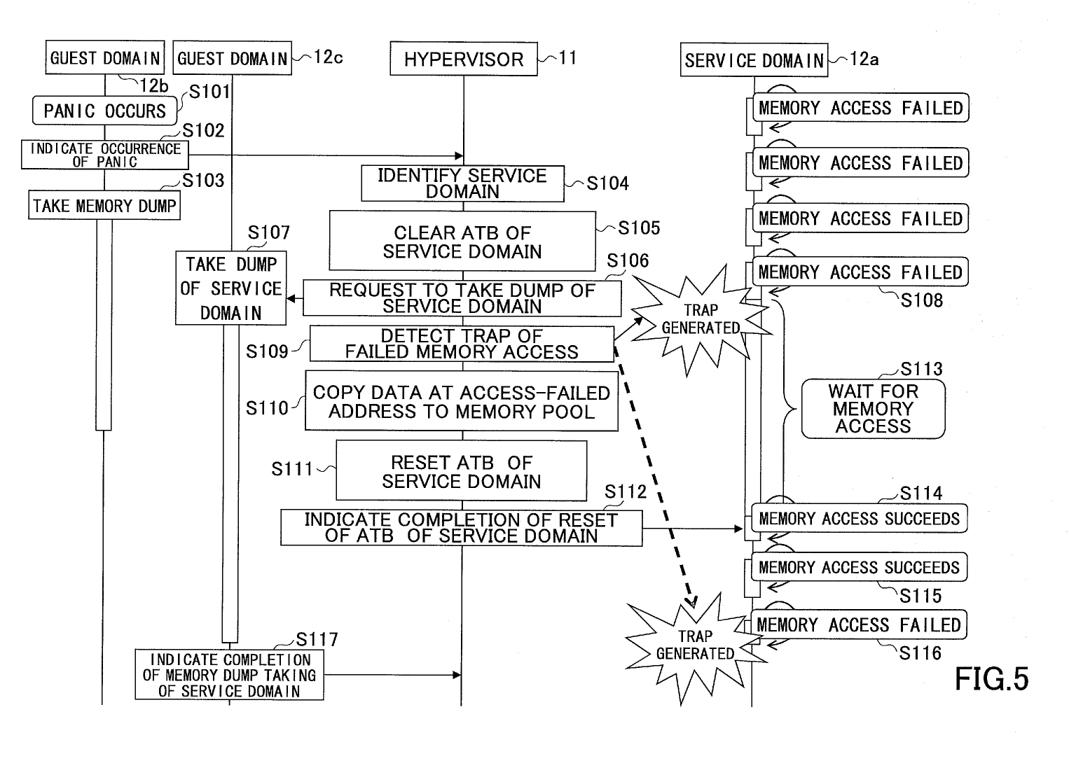

Procedures executed by the information processing apparatus 10 will be described in the following. FIG. 5 is a sequence chart illustrating an example of a procedure executed when a panic occurs in a guest domain.

For example, assume that a panic occurs on the OS 13b of the guest domain 12b in response to a detection of a fatal error (Step S101). In this case, the panic indication section 131b indicates status information designating a panic to the hypervisor 11 via a hypervisor API (Application Program Interface) (Step S102). The status information includes identification information about the guest domain 12b (domain number). Next, the memory dump taking section 132b executes a procedure for collecting a memory dump (Step S103). Namely, a snapshot of content of the memory 130b is stored into the disk 120b.

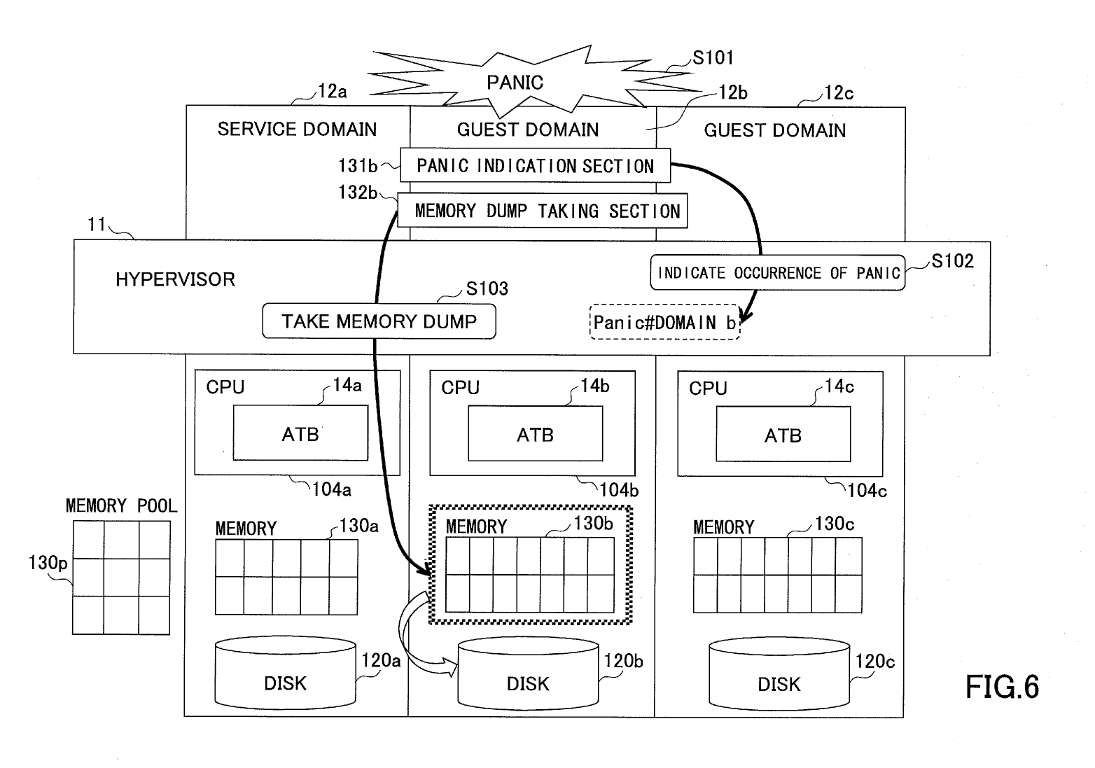

FIG. 6 is a schematic view illustrating an example of a procedure for collecting a memory dump of a domain 12 where a panic occurs. In FIG. 6, steps that have corresponding steps in FIG. 5 are assigned the same step numbers, respectively.

FIG. 6 illustrates an execution of steps for an occurrence of a panic on the guest domain 12b (Step S101), indication of the panic (Step S102), and collection of a memory dump (Step S103).

Here, after having collected the memory dump, the guest domain 12b inputs a reactivation instruction to the hypervisor 11. Consequently, the guest domain 12b is reactivated after an emergency stop.

Referring to FIG. 5 again, having indicated with the status information about the panic, the domain relation determination section 101 of the hypervisor 11 identifies one of the domains 12 (namely, the service domain 12a) that provides a service to the guest domain 12b (Step S104). The domain relation storage section 112 is referred to when identifying a service domain.

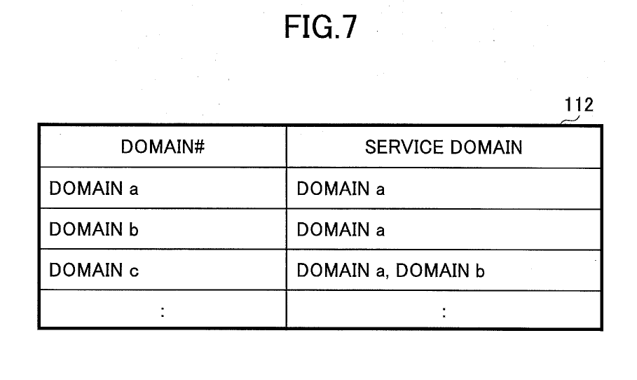

FIG. 7 is a schematic view illustrating an example of a configuration of the domain relation storage section 112. As illustrated in FIG. 7, the domain relation storage section 112 stores the domain numbers of the domains 12 and their respective service domain numbers. In FIG. 7, “domain a”, “domain b”, and “domain c” represent domain numbers of the service domain 12a, guest domain 12b, and guest domain 12c, respectively. Here, in FIG. 7, the domain numbers are represented by strings such as “domain a”, “domain b”, “domain c” for convenience's sake.

The domain relation determination section 111 extracts a domain number from the indicated status information, and obtains a service domain number that corresponds to the extracted domain number in the domain relation storage section 112. Based on FIG. 7, the “domain a” is obtained for the “domain b”. Namely, the service domain 12a is identified as the service domain of the guest domain 12b. The domain relation determination section 111 sends (indicates) the identified service domain number that corresponds to the service domain 12a to the ATB processing section 113. The identified service domain 12a is a domain 12 whose memory dump is to be collected in the following steps.

Next, the ATB processing section 113 of the hypervisor 11 clears (deletes) content of the address translation buffer 14a in the CPU 104a of the service domain 12a (Step S105). Namely, the address translation buffer 14a is invalidated.

Next, the dump request section 114 of the hypervisor 11 sends a request for collecting a memory dump of the service domain 12a via a hypervisor API to the domains 12 other than the service domain 12a and the guest domain 12b where the panic occurs (Step S106). At this moment, a range of physical addresses PA of the memory 130a of the service domain 12a is specified. Namely, it is the hypervisor 11 that has allocated the memory 130 of the domain 12. Therefore, the hypervisor 11 recognizes the range of physical addresses PA of the memory 130 of the domain 12. In the present embodiment, the guest domain 12c is an only domain 12 other than the service domain 12a and the guest domain 12b where the panic occurs. Therefore, the request for collecting a memory dump of the service domain 12 is sent to the guest domain 12c.

Next, the memory dump taking section 132c of the guest domain 12c copies a snapshot of content of an area in the main memory unit 103 (namely, the memory 130a) that corresponds to the range of the specified physical addresses PA into the disk 120c to preserve it as the memory dump (Step S107).

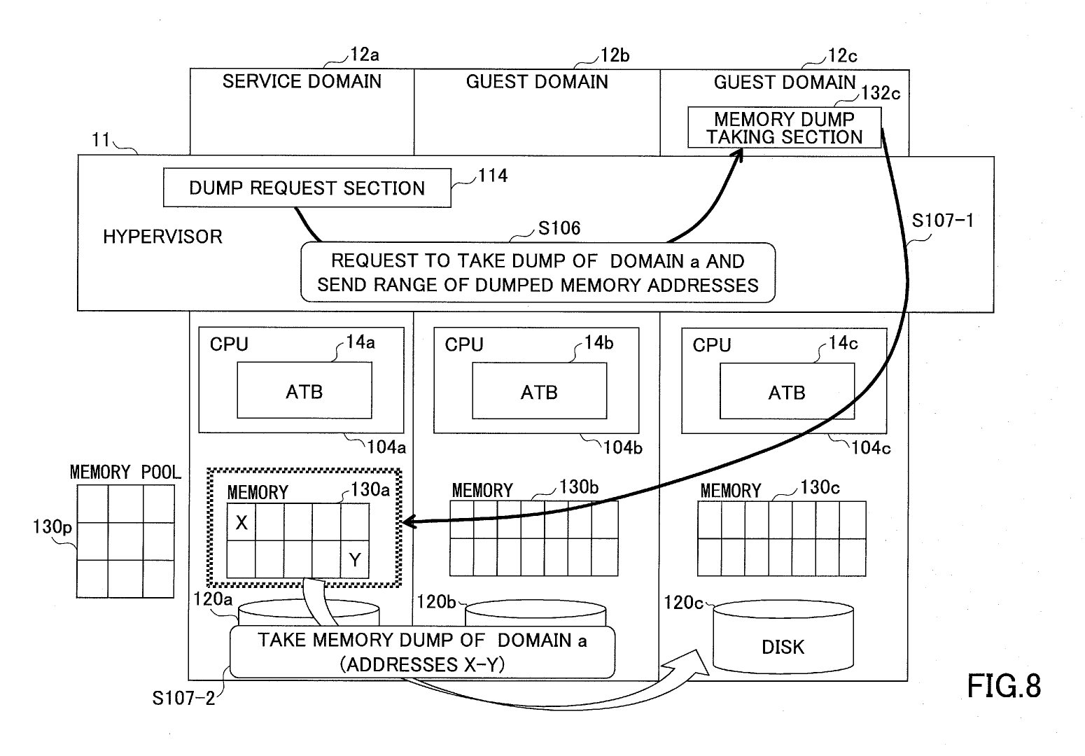

FIG. 8 is a schematic view illustrating an example of a procedure for collecting a memory dump of a service domain. In FIG. 8, steps that have corresponding steps in FIG. 5 are assigned the same step numbers, respectively.

The dump request section 114 of the hypervisor 11 makes a request for collecting a memory dump of the service domain 12a to the memory dump taking section 132c of the guest domain 12c (Step S106). The request for collection specifies a range of physical addresses PA (addresses X-Y in FIG. 8) of the memory 130a. In response to the request for the collection, the memory dump taking section 132c copies a snapshot of content of an area in the main memory unit 103 (namely, the memory 130a) that corresponds to the range into the disk 120c to preserve it as the memory dump (Steps S107-1, S107-2). Namely, what is specified for the memory dump is not a range of virtual addresses VA in the service domain 12a, but the range of physical addresses PA, hence it is possible for the memory dump taking section 132c to specify the range for the memory dump in the main memory unit 103 even if the range is the memory area for another domain.

Referring to FIG. 5 again, the memory dump taken at Step S107 represents a state of the memory 130a when the panic occurs in the guest domain 12b. Namely, as the address translation buffer 14a is invalidated, the service domain 12a cannot access the memory 130a that has been accessible until then (Step S108). This is because the CPU 104a fails to translate a virtual address PA specified by the OS 13a to a physical address PA. Therefore, the content of the memory 130a is not updated, but protected. Consequently, the memory dump is collected that represents the state of the memory 130a when the panic occurs in the guest domain 12b.

When the CPU 104a fails in address translation, it generates a trap representing a failure of the address translation to indicate the trap to the hypervisor 11. The trap processing section 115 of the hypervisor 11 detects the trap (Step S109).

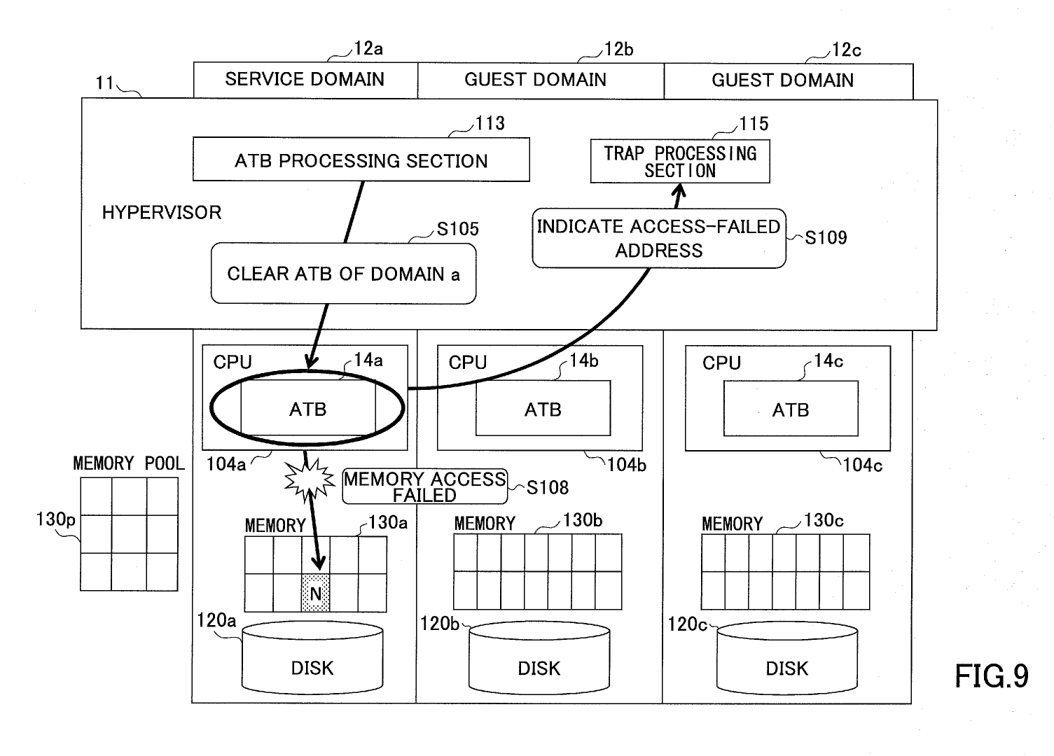

FIG. 9 is a schematic view illustrating an example of a trap generated due to invalidation of an address translation buffer 14. In FIG. 9, steps that have corresponding steps in FIG. 5 are assigned the same step numbers, respectively.

As illustrated in FIG. 9, the ATB processing section 113 of the hypervisor 11 clears the address translation buffer 14a of the CPU 104a of the service domain 12a based on the domain number of the service domain 12a sent by the domain relation determination section 111 (Step S105). With the clearance (invalidation) of the address translation buffer 14a, the CPU 104a of the service domain 12 fails in address translation when accessing data in the memory 130 (Step S108). Thereupon, the CPU 104a generates a trap representing a failure of address translation. The trap processing section 115 of the hypervisor 11 detects the trap (Step S109).

Referring to FIG. 5 again, the trap processing section 115 identifies the service domain 12 as a domain 12 that fails in address translation based on the fact that the indication source of the trap is the CPU 104a. Namely, the hypervisor 11 recognizes correspondences between the CPUs 104 and the domains 12, respectively. Also, the trap includes an address (VA or RA) with which address translation failed. The trap processing section 115 translates the address into a physical address PA by referring to the address translation table 117, then indicates the translated physical address PA to the memory management section 116. The memory management section 116 copies data located at the physical address PA in the main memory unit 103 (for example, a page including the physical address PA) to a vacant area in the memory pool 130p (Step S110). Namely, the data that the service domain 12a has attempted to access is copied to the memory pool 130p.

Here, whether the address included in the trap is a VA or an RA depends on the configuration of the address translation buffer 14. Also, the method for translating into a physical address PA by the trap processing section depends on whether the address included in the trap is a VA or an RA. The configuration of the address translation buffer 14 and the method for translating an address included in the trap into a physical address will be described later.

Next, the ATB processing section 113 of the hypervisor 11 resets mapping information between the address to be accessed (VA or RA) and the physical address PA of the copy destination in the address translation buffer 14a (Step S111). Namely, the physical address PA that corresponds to the address to be accessed is set to the address of the copy destination in the memory pool 130p. Next, the ATB processing section 113 indicates completion of the resetting of the address translation buffer 14a to the CPU 104a of the service domain 12a to direct a retry of the memory access (Step S112).

The service domain 12a waits for an opportunity of memory access to the access-failed data after generating the trap until receiving the indication at Step S112 (Step S113). In response to the indication of completion of the resetting of the address translation buffer 14a from the hypervisor 11, the service domain 12a resumes access to the memory 130a (Step S114). At this moment, the physical address PA that corresponds to the access-failed data is recorded in the address translation buffer 14a. Therefore, address translation of the data succeeds.

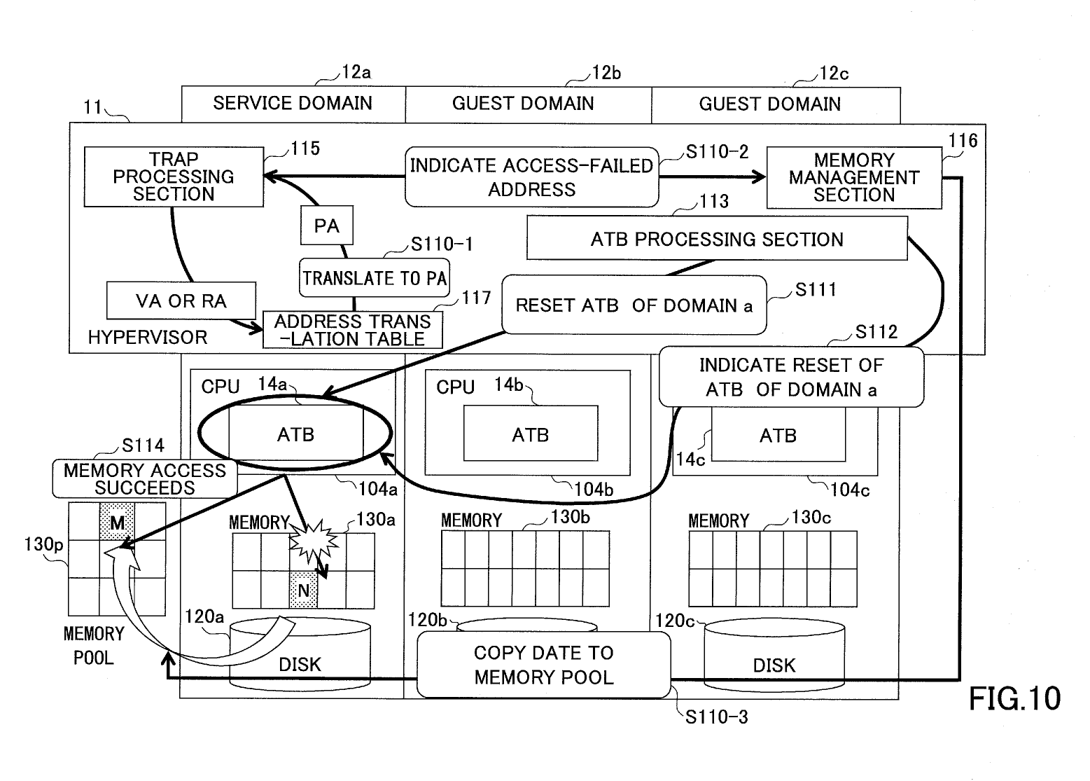

FIG. 10 is a schematic view illustrating an example of a procedure for resetting an address translation buffer 14. In FIG. 10, steps that have corresponding steps in FIG. 5 are assigned the same step numbers, respectively.

The trap processing section 115 of the hypervisor 11 translates an address (VA or RA) included in the detected trap into a physical address PA by referring to the address translation table 117 (Step S110-1). Next, the trap processing section 115 indicates the translated physical address PA to the memory management section 116 (Step S110-2). Assume that the physical address PA is an address N. The memory management section 116 copies data relevant to the address N in the memory 130a to a vacant area (address M in FIG. 10) in the memory pool 130p (Step S110-3). Next, the ATB processing section 113 resets mapping information between the address M of the copy destination and the access-failed address (VA or RA) in the address translation buffer 14a (Step S111). Having completed the resetting of the address translation buffer 14a, the ATB processing section 113 sends an indication of completion of the resetting of the address translation buffer 14 to the CPU 104a of the service domain 12 (Step S112). In response to the indication, the CPU 104a retries memory access. Namely, the CPU 104a succeeds in memory access to the address M in the memory pool 130p. In this way, the CPU 104a does not access the address N in the memory 130a, but the address M in the memory pool 130p. Consequently, the service domain 12a can continue its operation without updating content of the memory 130a. Namely, the service domain 12a can continue its operation by making read/write access to the data copied to the memory pool 130p.

Referring to FIG. 5 again, after Step S114, memory access in the service domain 12a succeeds for an address that is copied into the memory pool 130p and the mapping information is set in the address translation buffer 14a (Step S115), and fails in address translation for other addresses (Step S116). If address translation fails, a trap is generated again, and Steps S109 and after are repeated. Therefore, operation of the service domain 12a can be continued without being stopped completely. Namely, the service domain 12a can continue to offer its services.

On the other hand, when collection of a memory dump of the memory 130a in the service domain 12a is completed (stored into the disk 120c), the memory dump taking section 132c of the guest domain 12c sends an indication of completion of collection of the memory dump to the hypervisor 11 (Step S117).

After having received the indication of the completion, the memory management section 116 of the hypervisor 11 does not copy data into the memory pool 130p. Specifically, after having received the indication of the completion, if a trap is generated that indicates an address translation failure in the service domain 12a, the memory management section 116 indicates a physical address PA for the data to be accessed in the memory 130a to the ATB processing section 113. The ATB processing section 113 sets mapping information between the physical address PA and the address (VA or RA) of the data to be accessed in the address translation buffer 14a. Therefore, in this case, the data in the memory 130a is accessed. Having completed the collection of the memory dump of the memory 130a, the memory dump is not affected if the memory 130a is updated.

Here, collection of a memory dump by the guest domain 12c and an execution of Steps S108 and after are executed in parallel.

Next, a procedure executed by the hypervisor 11 in response to a detection of a trap will be described with generalization.

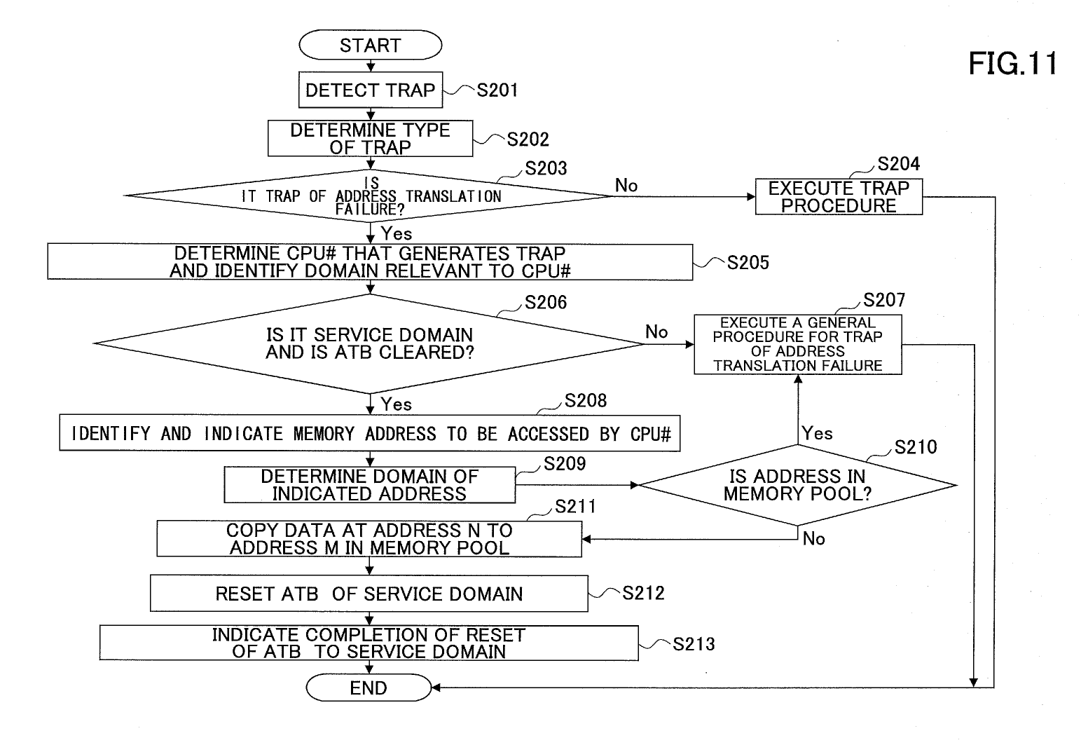

FIG. 11 is a flowchart illustrating an example of a procedure executed by a hypervisor in response to a detection of a trap.

When detecting a trap (Step S201), the trap processing section 115 of the hypervisor 11 determines the type of the trap (Step S202). The type of a trap can be determined based on information included in the trap. If the type of the trap is a trap other than an address translation failure (Step S203 No), the trap processing section 115 executes a procedure that corresponds to the type of the trap (Step S204).

On the other hand, if the type of the trap is an address translation failure (Step S203 Yes), the trap processing section 115 determines the identification number of the CPU 104 that generates the trap based on the information included in the trap to identify a domain 12 that corresponds to the CPU 104 (Step S205).

If the domain 12 is not a service domain, or if the address translation buffer 14 of the CPU 104 is not cleared (invalidated) (Step S206 No), a general procedure that handles an address translation failure trap is executed (Step S207). Details of the general procedure will be described later.

On the other hand, if the domain 12 is a service domain, and the address translation buffer 14 of the CPU 104 in the domain 12 is cleared (invalidated) (Step S206 Yes), the trap processing section 115 identifies an address PA (address N is assumed here) that corresponds an address VA or RA included in the trap. The trap processing section 115 indicates the identified physical address PA to the memory management section 116 of the hypervisor 11 (Step S208).

Whether the domain 12 is a service domain of other domains 12 can be determined by referring to the domain relation storage section 112. Namely, if the domain number of the domain 12 is stored in the domain relation storage section 112 as a service domain, the domain 12 is a service domain. Also, an address PA that corresponds to the address included in the trap is calculated by referring to the address translation table 117.

Next, the memory management section 116 determines the domain of the indicated address N (Step S209). Here, the hypervisor 11 (memory management section 116) recognizes a range of physical addresses of the memory 130 or memory pool 130p for each of the domains 12. Therefore, the memory management section 116 can determine whether the address N is included in the memory 130 of the domain 12 or in the memory pool 130p.

If the address N is included in the memory pool 130p (Step S210 Yes), Step S207 (the general procedure for an address translation failure trap) is executed.

If the address N is out of the memory pool 130p (Step S210 No), the memory management section 116 copies the data at the address N to a vacant area (assume the address M) in the memory pool 130p, and indicates the address M of the copy destination to the ATB processing section 113 (Step S211). The ATB processing section 113 resets mapping information between the indicated address M and the address that the CPU 104a failed to access into the address translation buffer 14 (Step S212). Next, the ATB processing section 113 indicates completion of the resetting of the address translation buffer 14 to the service domain 12a (Step S213).

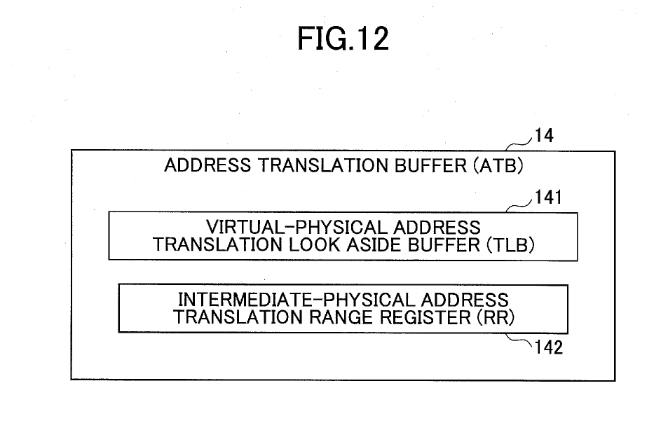

Next, a concrete example of a configuration of the address translation buffer 14 will be described. FIG. 12 is a schematic view illustrating a first example of a configuration of address translation buffers.

In FIG. 12, the address translation buffer 14 includes a virtual-physical address translation look aside buffer 141 (called a “TLB 141”, hereafter) and an intermediate-physical address translation range register 142 (called an “RR 142”, hereafter). The TLB (Translation Look aside Buffer) 141 holds mapping information between a virtual address VA and a physical address PA. The RR (Range Register) 142 holds mapping information between an intermediate address RA that corresponds to a physical address for the OS 13 on a domain 12 and a physical address PA.

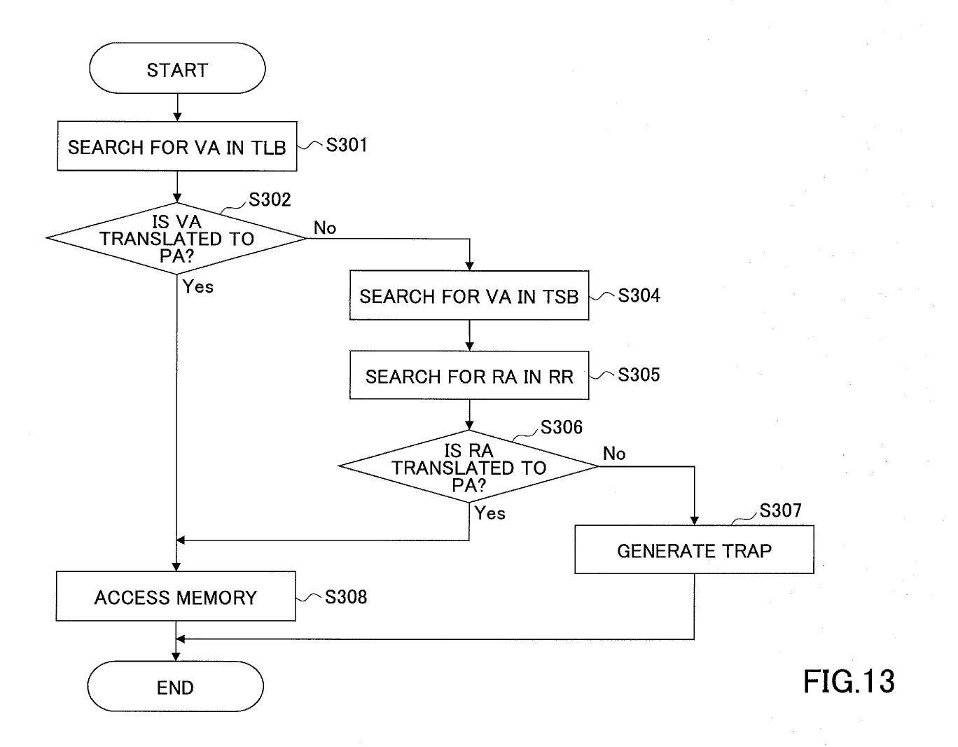

If the address translation buffer 14 has the configuration illustrated in FIG. 12, a virtual address VA is translated into a physical address PA by a procedure illustrated in FIG. 13.

FIG. 13 is a schematic view illustrating an example of a procedure for address translation using a TLB and an RR.

First, the CPU 104 searches for a virtual address VA to be accessed in the TLB 141 (Step S301). If translation from the virtual address VA to a physical address PA succeeds using the TLB 141 (Step S302 Yes), the CPU 104 accesses the translated physical address PA.

On the other hand, if translation from the virtual address VA to a physical address PA fails using the TLB 141 (Step S302 No), the CPU 104 generates a trap, and indicates the trap to the OS 13. The trap specifies the virtual address VA. In response to the trap, the OS searches for the virtual address VA specified in the trap in the TSB 133 (Step S304). The virtual address VA is translated into an intermediate address RA using the TSB 133. Here, according to the present embodiment, the TSB 133 is not a buffer to be cleared (invalidated), so translation using the TSB 133 succeeds. The OS 13 accesses the translated intermediate address. In response to the access, the CPU 104 searches for the translated intermediate address in the RR 142 (Step S305). If translation from the intermediate address RA to a physical address PA using the RR 142 succeeds (Step S306 Yes), the CPU 104 accesses the translated physical address PA.

On the other hand, if translation from the intermediate address RA to a physical address PA using the RR 142 fails (Step S306 No), the CPU 104 generates an address translation failure trap (Step S307).

Therefore, if the address translation buffer 14 includes the TLB 141 and RR 142, clearing (invalidation) of the address translation buffer 14 is executed for the TLB 141 and RR 142 at Step S105 in FIG. 5 and at Step S105 in FIG. 9, respectively. Namely, the ATB processing section 113 of the hypervisor 11 clears the TLB 141. Also, the ATB processing section 113 clears the RR 142.

This makes translation from a virtual address VA into a physical address PA fail, and generate a trap at Step S307 in FIG. 13.

The trap includes an intermediate address RA. Therefore, in this case, at Step S110-1 in FIG. 10, the trap processing section 115 can obtain a physical address PA by searching for the intermediate address RA in the address translation table 117, because the address translation table 117 stores mapping information between the intermediate address RA and the physical address PA.

Also, at Step S111 in FIG. 5 or FIG. 10 for executing the procedure for resetting the address translation buffer 14, the ATB processing section 113 sets a physical address PA of the copy destination for the intermediate address RA in the RR 142a. Here, setting for the TLB 141a may not be executed. This is because if “No” is determined at Step S302 in FIG. 13, “Yes” is determined at Step S306, and the address translation succeeds.

Further, if the address translation buffer 14 has the configuration illustrated in FIG. 12, the trap processing section 115 extracts an intermediate address RA in the trap at Step S208 in FIG. 11. The trap processing section 115 obtains a physical address PA that corresponds to the intermediate address RA from the address translation table 117. The trap processing section 115 sets mapping information between the intermediate address RA and the physical address PA into the RR 142. Consequently, the CPU 104 can access the physical address PA.

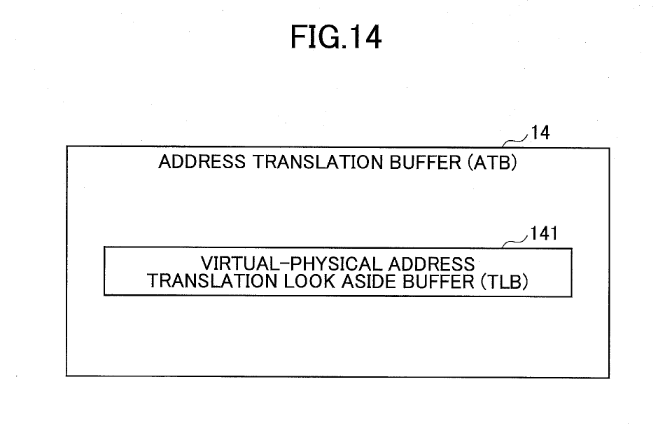

Next, a second configuration example of the address translation buffer 14 will be described. FIG. 14 is a schematic view illustrating a second example of a configuration of the address translation buffer 14. In FIG. 14, the same elements as in FIG. 12 are assigned the same numerical codes, and their description is omitted. In the second configuration example, the address translation buffer 14 does not include an RR 142.

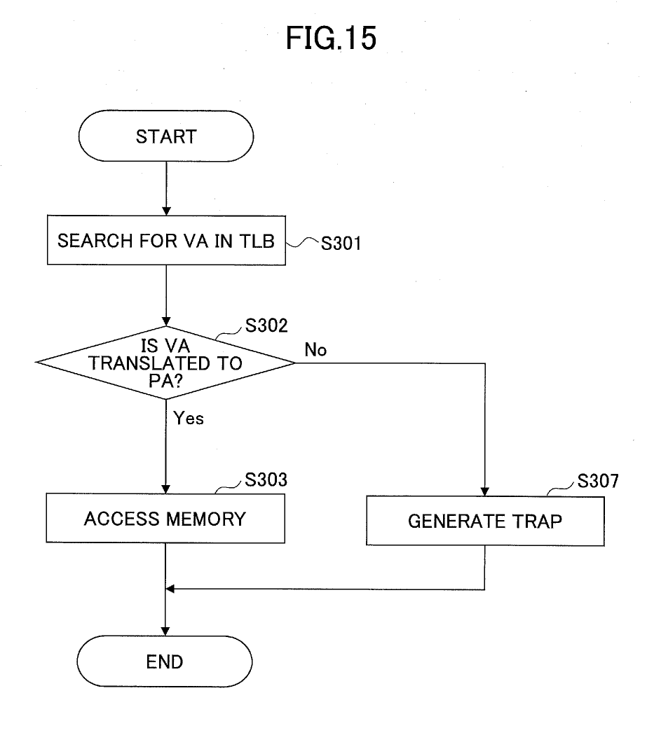

If the address translation buffer 14 has the configuration illustrated in FIG. 14, a virtual address VA is translated into a physical address PA by a procedure illustrated in FIG. 15.

FIG. 15 is a schematic view illustrating an example of the procedure for address translation using a TLB. In FIG. 15, the same steps as in FIG. 13 are assigned the same step numbers, and their description is omitted appropriately.

As illustrated in FIG. 15, if the address translation buffer 14 has the configuration illustrated in FIG. 14, and if translation from the virtual address VA into a physical address PA fails using the TLB 141 (Step S302 No), the CPU 104 generates a trap of address translation failure.

Therefore, if the address translation buffer 14 has the configuration illustrated in FIG. 14, clearing (invalidation) of the address translation buffer 14 may be executed for the TLB 141. This makes translation from a virtual address VA into a physical address PA fail, and generates a trap at Step S307 in FIG. 15.

The trap includes a virtual address VA. Therefore, in this case, at Step S110-1 in FIG. 10, the trap processing section 115 first translates the virtual address VA into an intermediate address RA by referring to the TSB 133a of the service domain 12a. Then, the trap processing section 115 obtains a physical address PA by searching for the intermediate address RA in the address translation table 117.

Also, at Step S111 in FIG. 5 or FIG. 10 for executing the procedure for resetting the address translation buffer 14, the ATB processing section 113 sets a physical address PA of the copy destination for the intermediate address RA in the RR 141a.

Further, if the address translation buffer 14 has the configuration illustrated in FIG. 14, the trap processing section 115 extracts the virtual address VA in the trap at Step S208 in FIG. 11. The trap processing section 115 obtains an intermediate address RA that corresponds to the virtual address VA from the TSB 133 of the domain 12 that generates the trap. Next, the trap processing section 115 obtains a physical address PA that corresponds to the intermediate address RA from the address translation table 117. The trap processing section 115 sets mapping information between the virtual address VA and the physical address PA into the TLB 141. Consequently, the CPU 104 can access the physical address PA.

As described above, according to the present embodiment, if a panic occurs at a domain 12, the address translation buffer 14 of a service domain 12 that serves the domain 12 is invalidated. Therefore, access to the memory 130 of the service domain 12 is suppressed, and the memory 130 is kept in a state in which no update is allowed. A memory dump of the memory 130 is collected under such a circumstance. Consequently, a snapshot of the memory 130 of the service domain 12 can be collected as a memory dump when the panic occurs. Namely, it is possible to increase a likelihood for collecting a memory dump that is useful for investigating a cause of the panic.

Also, if memory access is attempted in the service domain 12, data to be accessed is copied into the memory pool 130p that has not been allocated to any of the domains 12. The physical address PA of the copy destination is set into the address translation buffer 14 of the service domain 12. Consequently, the service domain 12 can access the data to be accessed and continue its operation. Namely, a memory dump of the memory 130 of the service domain 12 can be collected without stopping services provided by the service domain 12.

It is noted that the present embodiment is effective for a case where there are multiple service domains 12. Namely, procedures described in the present embodiment may be applied to each of the multiple service domains 12. In this case, one or more domains 12 may collect memory dumps of the service domains 12. Also, a memory dump may be collected for a domain 12 other than the service domains 12 and a domain 12 where a panic occurs.

Here, according to the present embodiment, the address translation buffer 14 is an example of a correspondence information storage section. The ATB processing section 113 is an example of a correspondence information processing section. The memory dump taking section 132 is an example of a preservation section.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus running a plurality of virtual machines, comprising:
a correspondence information storage section configured to store correspondence information between a virtual address and a physical address, the correspondence information being used by a second virtual machine when executing a procedure relevant to a first virtual machine;
a correspondence information processing section configured to invalidate the correspondence information in response to an occurrence of a panic in the first virtual machine; and
a preservation section configured to preserve content of a memory area allocated to the second virtual machine into a storage device.

2. The information processing apparatus as claimed in claim 1, further comprising:
a memory management section configured to copy data into a memory area not allocated to any one of the plurality of virtual machines in response to a trap generated based on the invalidation of the correspondence information when access is attempted to the data in the memory area allocated to the second virtual machine in the second virtual machine,
wherein the correspondence information processing section stores a physical address of a destination of the copy into the correspondence information storage section.

3. The information processing apparatus as claimed in claim 1, wherein the second virtual machine is a virtual machine providing a service to the first virtual machine.

4. A method of collecting a memory dump executed by an information processing apparatus running a plurality of virtual machines, the method comprising:
storing correspondence information between a virtual address and a physical address, the correspondence information being used by a second virtual machine when executing a procedure relevant to a first virtual machine;
invalidating the correspondence information in response to an occurrence of a panic in the first virtual machine; and
preserving content of a memory area allocated to the second virtual machine into a storage device.

5. The method of collecting the memory dump as claimed in claim 4, the method further comprising:
copying data into a memory area not allocated to any one of the plurality of virtual machines in response to a trap generated based on the invalidation of the correspondence information when access is attempted to the data in the memory area allocated to the second virtual machine in the second virtual machine,
wherein the invalidating stores a physical address of a copy destination into the correspondence information storage section.

6. The method of collecting the memory dump as claimed in claim 4, wherein the second virtual machine is a virtual machine providing a service to the first virtual machine.

7. A computer-readable recording medium having a program stored therein for causing an information processing apparatus running a plurality of virtual machines to execute a method of collecting a memory dump, the method comprising:
storing correspondence information between a virtual address and a physical address, the correspondence information being used by a second virtual machine when executing a procedure relevant to a first virtual machine;
invalidating the correspondence information in response to an occurrence of a panic in the first virtual machine; and
preserving content of a memory area allocated to the second virtual machine into a storage device.

8. The computer-readable recording medium as claimed in claim 7, the method comprising:
copying data into a memory area not allocated to any one of the plurality of virtual machines in response to a trap generated based on the invalidation of the correspondence information when access is attempted to the data in the memory area allocated to the second virtual machine in the second virtual machine,
wherein the invalidating stores a physical address of a copy destination into the correspondence information storage section.

9. The computer-readable recording medium as claimed in claim 7, wherein the second virtual machine is a virtual machine providing a service to the first virtual machine.
